(19) United States
(12) Patent Application Publication
(10) Pub. No.: US 2013/0312330 A1
(43) Pub. Date: Nov. 28, 2013

(54) SEALING ARRANGEMENTS FOR DOORS OF MOTOR VEHICLES AND METHODS OF MAKING THE SAME

(71) Applicant: Glenn Sturgell, Maumee, OH (US)

(72) Inventor: Glenn Sturgell, Maumee, OH (US)

(73) Assignee: FAURECIA INTERIOR SYSTEMS, INC., Auburn Hills, MI (US)

(21) Appl. No.: 13/478,416

(22) Filed: May 23, 2012

(51) Int. Cl. B60J 10/08

(52) U.S. Cl. 49/70; 49/506

(57) ABSTRACT

Sealing arrangements for doors of motor vehicles, and methods for making such sealing arrangements are provided herein. In one example, a sealing arrangement for a door of a motor vehicle comprises an elongated seal. A heating element extends longitudinally through the elongated seal.

### TECHNICAL FIELD

The present invention relates generally to seals for doors of motor vehicles, and more particularly to sealing arrangements that include heating elements for doors of motor vehicles and methods for making such sealing arrangements.

### BACKGROUND

Motor vehicles commonly employ seals that interface with various surfaces of a door to prevent the ingress of water, other outside elements, and/or noise into the vehicle. For example, door window seals, such as outer weatherstrips and inner window seals, are used to seal the outer and inner areas, respectively, surrounding door windows. In other examples, door seals are used to seal the areas between the vehicle body and the doors.

During cold weather conditions, such as in the wintertime, moisture that may have formed around the door window seals and/or door seals can freeze, causing the door window(s) and/or the door(s) to become affixed to the seals. As such, it may be difficult to open the door window(s) and/or door(s) of the motor vehicle.

One attempt to address this problem is disclosed in U.S. Pat. No. 6,296,296 issued to Sekishiro et al. In Sekishiro, a door trim panel is mounted and secured to a door of a motor vehicle. The door trim panel includes an integrally formed defroster duct panel. The defroster duct panel has a duct outlet that is positioned to distribute warm air from the vehicle's heating, ventilation, and air-conditioning (HVAC) system along the inside surface of a rollup glass window of the door to defrost the glass window. If the window seal(s) is frozen to the glass window, the warm air from the defroster duct panel will eventually thaw any ice or frost formed between the window seal(s) and the glass window. Because it takes time for the motor vehicle's engine to heat up, the air initially distributed from the HVAC system through the defroster duct panel is relatively cold during cold weather conditions. As such, the window seal(s) may be frozen to the glass window for an extended period of time making it difficult to open the window. Moreover, the defroster duct panel is not configured to distribute warm air onto the door seals to thaw any ice or frost that may have formed between the door seal and the door, thereby making it potentially difficult to open the door in cold weather conditions.

Accordingly, it is desirable to provide a sealing arrangement for a door of a motor vehicle that can relatively quickly thaw any ice or frost that may have formed between the sealing arrangement and the various surfaces of the door to facilitate opening the door window(s) and/or door(s) of the motor vehicle, and methods for making such sealing arrangements. Furthermore, other desirable features and characteristics of the present invention will become apparent from the subsequent detailed description and the appended claims, taken in conjunction with the accompanying drawings and the foregoing technical field and background

### BRIEF SUMMARY

Sealing arrangements for doors of motor vehicles, and methods for making such sealing arrangements are provided herein. In accordance with an embodiment, a sealing arrangement for a door of a motor vehicle comprises an elongated seal. A heating element extends longitudinally through the elongated seal.

In accordance with another embodiment, a method of making a sealing arrangement for a door of a motor vehicle is provided. The method comprises the step of positioning an elongated seal to interface with a door window, a portion of an interior door trim panel, and/or another portion of the door. The elongated seal has a heating element that extends longitudinally through the elongated seal.

### BRIEF DESCRIPTION OF THE DRAWINGS

The present invention will hereinafter be described in conjunction with the following drawing figures, wherein like numerals denote like elements, and wherein:

FIG. 1 is a perspective view of a motor vehicle in accordance with an embodiment;

FIG. 2 is a side view of a door of a motor vehicle in accordance with an embodiment;

FIG. 3 is a sectional view of a portion of the door depicted in FIG. 2 along line 3-3 in accordance with an embodiment;

FIG. 4 is a sectional view of a portion of the motor vehicle depicted in FIG. 1 along line 4-4 in accordance with an embodiment;

FIG. 5 schematically illustrates a heating element electrically coupled to one of a plurality of wire harnesses of a motor vehicle in accordance with an embodiment; and

FIG. 6 is a flowchart of a method of making a sealing arrangement for a door of a motor vehicle in accordance with an embodiment.

### DETAILED DESCRIPTION

The following Detailed Description is merely exemplary in nature and is not intended to limit the invention or the application and uses of the invention. Furthermore, there is no intention to be bound by any theory presented in the preceding background or the following detailed description.

Various embodiments contemplated herein relate to sealing arrangements for doors of motor vehicles, and methods for making such sealing arrangements. Unlike the prior art, the embodiments taught herein provide a sealing arrangement that comprises an elongated seal and a heating element. The elongated seal is positioned to interface with a door window, a portion of an interior door trim panel that may be mounted to the door's structure, and/or another portion of the door. In one embodiment, the elongated seal is configured to sealingly interface with the door window and the door. For example, the elongated seal may be an outer weatherstrip that is disposed along an exterior portion of the door around at least a portion of the door window or an inner window seal that is disposed along an interior portion of the door around at least a portion of the door window. The outer weatherstrip seals the outer perimeter area of the door window and helps prevents the ingress of water, other outside elements, and/or noise into the door. The inner window seal seals the inner perimeter area of the door window and helps prevent the ingress of water, other outside elements, and/or noise into the passenger compartment. In another embodiment, the elongated seal is a door seal that is configured to sealingly interface with the inner perimeter areas of the door and the body structure of the motor vehicle to prevent the ingress of water, other outside elements, and/or noise into the passenger compartment.

The heating element extends longitudinally through the elongated seal. In an embodiment, the heating element is electrically coupled to an electrical harness, e.g., door harness, instrument panel harness (IP harness), or a main body harness, and produces heat via electrical resistance. The heat is conducted from the heating element through the elongated seal. At freezing conditions, such as in the winter time before the motor vehicle has run sufficiently long to warm up, the heating element can rapidly heat the elongated seal to a temperature of greater than about 0° C., for example from about 5 to about 35° C. As such, any ice or frost that may have formed between the sealing arrangement and the various surfaces of the door can quickly melt to facilitate opening the door window(s) and/or door(s) of the motor vehicle.

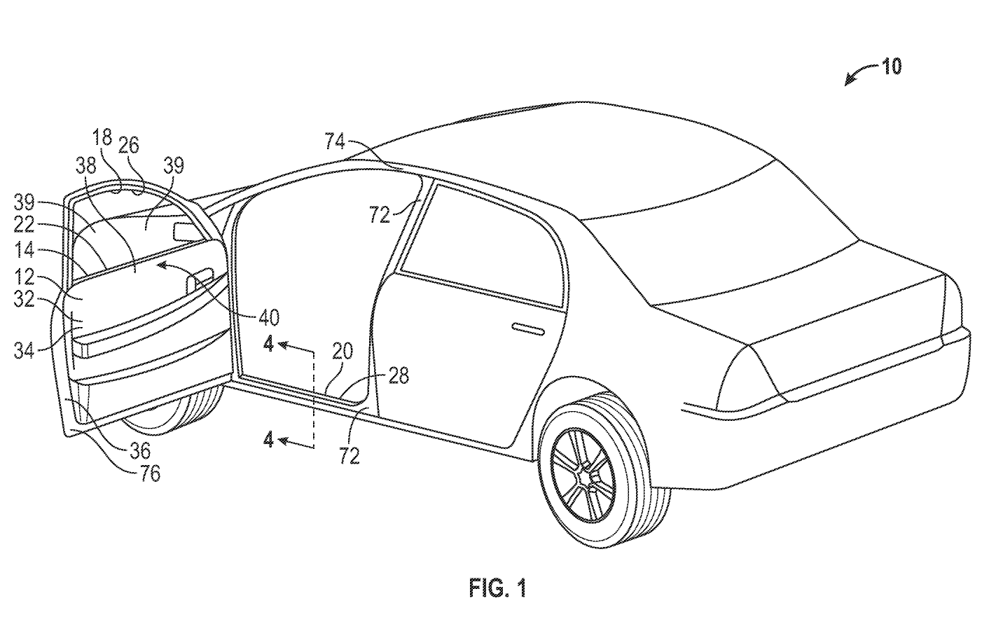

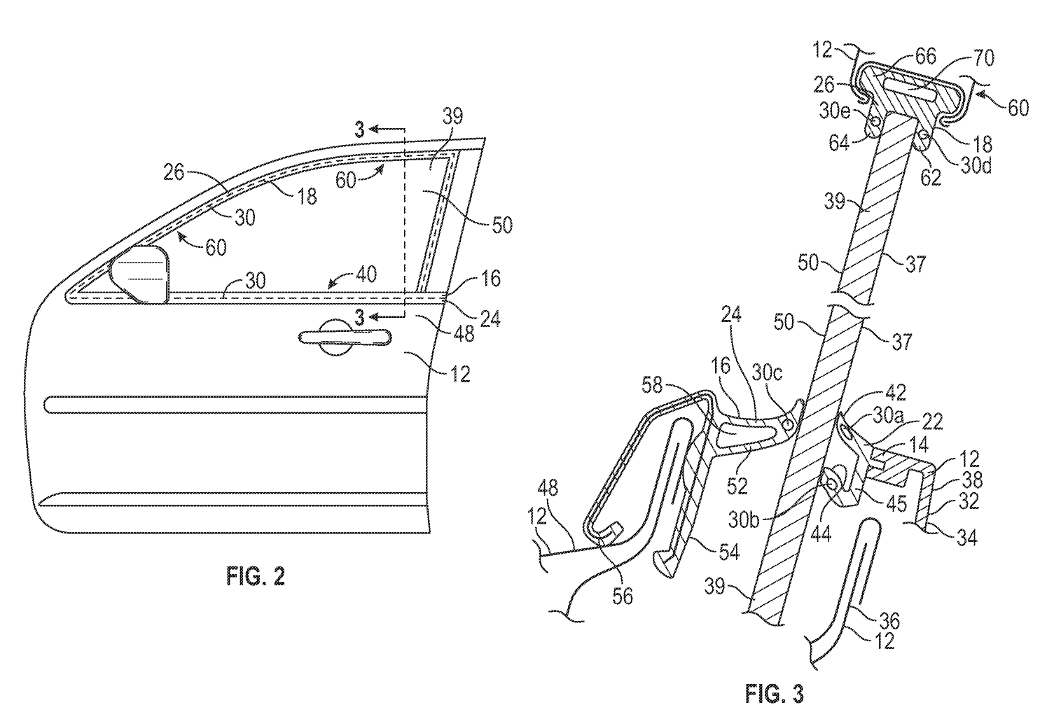

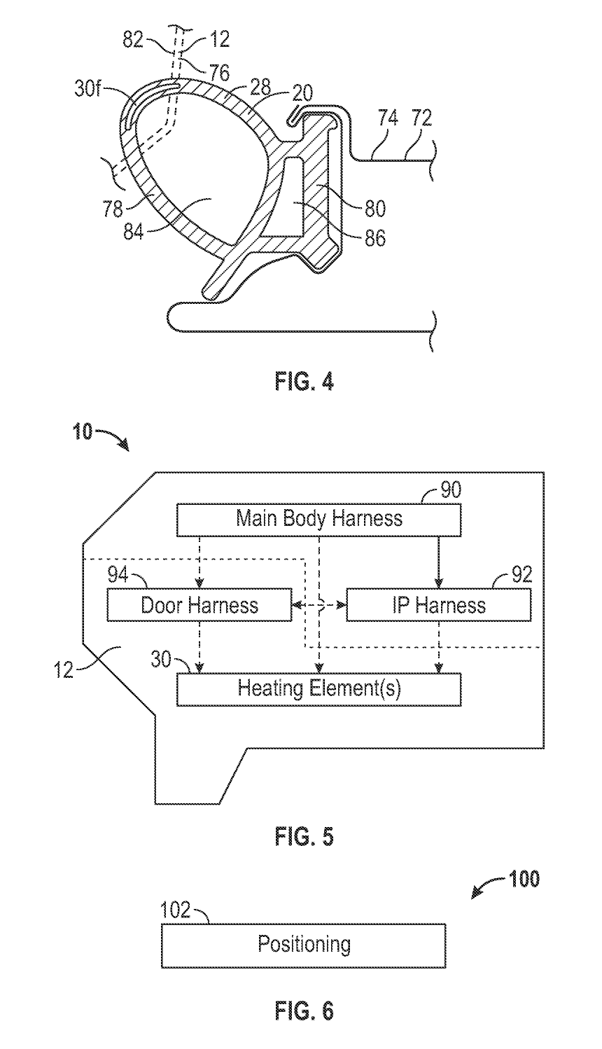

Referring to FIGS. 1 and 2, a perspective view of a motor vehicle 10 and a side view of a door 12 of the motor vehicle 10, respectively, in accordance with an embodiment are provided. As illustrated, a plurality of sealing arrangements 14, 16, 18, and 20 interface with or are positioned to interface with the door 12. The sealing arrangements 14, 16, 18, and 20 each comprise an elongated seal 22, 24, 26, or 28 and at least one heating element designated generally as reference number 30 (see also FIGS. 3 and 4) that extends longitudinally through the corresponding elongated seal 22, 24, 26, or 28.

The elongated seals 22, 24, 26, and 28 may be constructed from any one of a variety of elastomeric and/or polymeric materials, such as EPDM or the like, as are well known in the art so that the elongated seals 22, 24, 26, and 28 are relatively compliant to provide enhanced sealing. In an embodiment, the heating elements 30 are constructed of an electrically resistive material, such as Nichrome or the like, so that the heating elements 30 produce heat, increasing the temperature of the elongated seals 22, 24, 26, and 28, when an electric current is passed through the heating elements 30. The heating elements 30 may be configured the same or independently as a wire, ribbon, strip, or the like. As such, the elongated seals 22, 24, 26, and 28 may be formed having a predetermined cross-sectional shape, for example, by extruding an elastomeric or polymeric material longitudinally over a wire, ribbon, or strip that defines the respective heating element 30.

Referring also to FIG. 3, a sectional view of a portion of the door 12 is provided. In an embodiment, the sealing arrangement 14 further comprises an interior door trim panels 32 that is arranged along an interior portion 34 of the door 12. The interior door trim panel 32 is mounted and secured to a structure 36 of the door 12. The elongated seal 22 is disposed along and coupled to an upper portion 38 of the interior door trim panel 32, e.g., via a tongue and groove arrangement or the like. Coupling the elongated seal 22 to the interior door trim panel 32 can reduce part complexity and facilitate manufacturing.

In an embodiment, the elongated seal 22 is configured as an inner window seal that sealingly interfaces with an inside surface 37 of a door window 39 along a lower window opening perimeter portion 40 of the door 12. As illustrated, the elongated seal 22 has upper and lower compliant sealing elements 42 and 44 that extend from a base 45 of the elongated seal 22 and that contact the inside surface 37 of the door window 39. The elongated seal 22 has a heating element 30a that extends longitudinally through the upper compliant sealing element 42. The lower compliant sealing element 44 has an additional heating element 30b that extends longitudinally through the lower compliant sealing element 44. As such, when electric current is passed through the heating elements 30a and 30b, heat produced from the heating elements 30a and 30b is conducted along the upper and lower compliant sealing elements 42 and 44 to increase the temperature of the upper and lower compliant sealing elements 42 and 44. In one embodiment, the upper and lower compliant sealing elements 42 and 44 are rapidly heated, e.g., within minutes or less, to a temperature of greater than about 0° C., for example from about 5 to about 35° C., when the outside conditions are at or below 0° C. It is believed that by using multiple heating elements 30a and 30b, the heating elements 30a and 30b can be more strategically positioned along the elongated seal 22 to provide more rapid heating of the elongated seal 22. Moreover, by heating portions of the elongated seal 22 to a temperature of greater than 0° C., any ice or frost that may have formed along the elongated seal 22 is quickly melted. Additionally, by limiting the temperature of the portions of the elongated seal to about 35° C. or less, the elongated seal 22 does not become overheated or degraded.

In an embodiment, the elongated seal 24 of the sealing arrangement 16 is disposed along an exterior portion 48 of the door 12 opposite the elongated seal 22. The elongated seal 24 is configured as an outer weatherstrip that sealingly interfaces with an outside surface 50 of the door window 39 along the lower window opening perimeter portion 40 of the door 12. In one example, the elongated seal 24 has a compliant sealing element 52 that extends from a base 54 of the elongated seal 24 and that contacts the outside surface 50 of the door window 39. As illustrated, the base 54 is configured as a clip that attaches to the exterior portion 48 of the door 12 along the lower window opening perimeter portion 40. Extending longitudinally through the base 54 is a metal spring insert 56 that helps retain the elongated seal 24 on the door 12. A heating element 30c extends longitudinally through the compliant sealing element 52. As such, when electric current is passed through the heating element 30c, heat produced is conducted rapidly along the compliant sealing element 52 to increase the temperature of the sealing element 52, e.g., to a temperature of greater than about 0° C., for example from about 5 to about 35° C., when the outside conditions are at freezing conditions. Additionally, a channel 58 is formed through the compliant sealing element 52 to facilitate flexible movement of the compliant sealing element 52 against the door window 39.

In one embodiment, the elongated seal 26 of the sealing arrangement 18 is configured as an integral outer weatherstrip and inner window seal that sealingly interfaces with both the inside and outside surfaces 37 and 50 of the door window 39. As illustrated, the elongated seal 26 is disposed along an upper window opening perimeter portion 60 of the door 12. The elongated seal 26 has inner and outer compliant sealing elements 62 and 64 that extend from a base 66 of the elongated seal 26 and that contact the inside and outside surfaces 37 and 50, respectively, of the door window 39. The elongated seal 26 has a heating element 30d that extends longitudinally through the inner compliant sealing element 62. The outer compliant sealing element 64 has an additional heating element 30e that extends longitudinally through the outer compliant sealing element 64. As such, when electric current is passed through the heating elements 30d and 30e, heat produced is conducted rapidly along the inner and outer compliant sealing elements 62 and 64 to increase the temperature of the sealing elements 62 and 64, e.g., to a temperature of greater than about 0° C., for example from about 5 to about 35° C., when the outside conditions are at freezing conditions. Additionally, a channel 70 is formed through the base 66 to facilitate flexible movement of the base 66 against the door window 39 to enhance sealing when the door window 39 is in or approaching a closed position.

Referring to FIGS. 1 and 4, in an embodiment, the elongated seal 28 of the sealing arrangement 20 is disposed along a door opening perimeter portion 72 of a body structure 74 of the motor vehicle 10. The elongated seal 28 is configured as a door seal that sealingly interfaces with an inner perimeter portion 76 of the door 12. In particular, the elongated seal 28 has a compliant sealing element 78 that extends from a base 80 of the elongated seal 28 and that contacts the inner perimeter portion 76 of the door 12 when the door 12 is in a closed position 82. A heating element 30f extends longitudinally through the compliant sealing element 78. As such, when electric current is passed through the heating element 30f, heat produced is rapidly conducted along the compliant sealing element 78 to increase the temperature of the sealing element 78, e.g., to a temperature of greater than about 0° C., for example from about 5 to about 35° C., when the outside conditions are at freezing conditions. Additionally, channels 84 and 86 extend through the compliant sealing element 78 and the base 80, respectively, to facilitate flexible movement of the compliant sealing element 78 against the door 12.

Referring to FIG. 5, a schematic depiction of a heating element 30 electrically coupled to one of a plurality of wire harnesses of the motor vehicle 10 is provided. The motor vehicle 10 comprises a main body harness 90, an IP harness 92, and a door harness 94. The harnesses 90, 92, and 94 are well known to those skilled in the art and each of the harnesses 90, 92, and 94 includes a plurality of cables and/or wires that are configured to transmit signals and/or electrical power to various modules, components, assemblies, sub-assemblies, and the like. The main body harness 90 is located in the motor vehicle 10 and is electrically coupled to the IP harness that is located in an instrument panel (not shown). The door harness 94 is located in the door 12 and is electrically coupled to the main body harness 90 or the IP harness 92. Depending upon the electrical architecture of the motor vehicle 10, the heating element 30 may be electrically coupled to the main body harness 90, the IP harness 92, or the door harness 94 to facilitate packaging and/or manufacturing.

Referring to FIG. 6, a flowchart of a method 100 of making a sealing arrangement for a door of a motor vehicle in accordance with an embodiment is provided. The method 100 comprises the positioning an elongated seal (step 102) to interface with a door window, a portion of an interior door trim panel, and/or another portion of the door. The elongated seal has a heating element that extends longitudinally through the elongated seal.

While at least one embodiment has been presented in the foregoing detailed description of the disclosure, it should be appreciated that a vast number of variations exist. It should also be appreciated that the embodiment or embodiments are only examples, and are not intended to limit the scope, applicability, or configuration of the disclosure in any way. Rather, the foregoing detailed description will provide those skilled in the art with a convenient road map for implementing an embodiment of the disclosure. It being understood that various changes may be made in the function and arrangement of elements described in an embodiment without departing from the scope of the disclosure as set forth in the appended claims.

1. A sealing arrangement for a door of a motor vehicle, the sealing arrangement comprising:
an elongated seal that is formed of an elastomeric and/or polymeric material, wherein the elongated seal is configured to sealingly interface with a door window of the door; and
a heating element extending longitudinally through the elongated seal, wherein the heating element is formed of an electrically resistive material that is different from the elastomeric and/or polymeric material and that converts electric current to heat that is conducted through the elongated seal to the door window.

2. The sealing arrangement of claim 1, wherein the elongated seal is configured to be disposed along an exterior portion of the door.

3. The sealing arrangement of claim 1, wherein the elongated seal is configured to be disposed along an interior portion of the door.

4. The sealing arrangement of claim 1, wherein the elongated seal is configured to be disposed along a body structure of the motor vehicle and to sealingly interface with the door.

5. (canceled)

6. The sealing arrangement of claim 1, further comprising:
an interior door trim panel that is configured to be mounted to a structure of the door, wherein the elongated seal is disposed along a portion of the interior door trim panel.

7. The sealing arrangement of claim 6, wherein the interior door trim panel has an upper portion, and wherein the elongated seal is disposed along the upper portion.

8. The sealing arrangement of claim 1, further comprising:
an additional heating element that is spaced apart from the heating element and that extends longitudinally through the elongated seal.

9. The sealing arrangement of claim 1, wherein the heating element is configured to heat the elongated seal to a temperature of greater than about 0° C.

10. The sealing arrangement of claim 1, wherein the heating element is configured to heat the elongated seal to a temperature of from about 5 to about 35° C.

11. The sealing arrangement of claim 1, wherein the heating element is configured to electrically coupled to a door harness.

12. The sealing arrangement of claim 1, wherein the heating element is configured to electrically coupled to an instrument panel harness.

13. The sealing arrangement of claim 1, wherein the heating element is configured to electrically couple to a main body harness.

14. (Withdrawn But Currently Amended) A method of making a sealing arrangement for a door of a motor vehicle, the method comprising the step of:
positioning an elongated seal that has a heating element extending longitudinally therethrough and that sealingly interfaces with a door window, wherein the elongated seal is formed of an elastomeric and/or polymeric material and the heating element is formed of an electrically resistive material that is different from the elastomeric and/or polymeric material and that converts electric current to heat that is conducted through the elongated seal to the door window.
